(19) United States
(12) Patent Application Publication
(10) Pub. No.: US 2011/0060986 A1
(43) Pub. Date: Mar. 10, 2011

(54) Method for Controlling the Display of a Touch Screen, User Interface of the Touch Screen, and an Electronic Device using The Same

(76) Inventor: Chao-Kuang Yang, Hsichih (TW)

(21) Appl. No.: 12/690,139

(22) Filed: Jan. 20, 2010

(30) Foreign Application Priority Data
Sep. 10, 2009 (TW) 098130618

(51) Int. Cl. G06F 3/041; G06F 3/048

(52) U.S. Cl. 715/702; 345/173; 715/863

(57) ABSTRACT

A method for controlling a display of a touch screen, a user interface of the touch screen, and an electronic device using the same are disclosed. The method comprises: displaying at least one mode selection on the display of the touch screen, wherein each one of the at least one mode selections corresponds to a gesture control mode; receiving a selection command for selecting one of the at least one mode selections; entering the gesture control mode corresponding to the selected mode selection; receiving a gesture control command adapted for the entered gesture control mode; and executing a specific operation according to the gesture control command.

### BACKGROUND OF THE INVENTION

1. Field of the Invention

The present invention relates to a method for controlling a display of a touch screen, a user interface of the touch screen, and an electronic device using the same.

2. Description of the Related Art

The development of touch screens has provided users with an alternative to using peripheral devices such as a keyboard or a mouse to input data/instructions. All kinds of touch devices comprising touch screens bring convenience to people's lives; for example, a user can write or click on the touch screen of a personal data assistant to input data/instructions.

Nowadays some touch screens have evolved to have multi-point input capabilities; for example, the touch screen of the iPhone™ provides multi-touch gesture control functions. The multi-touch capabilities of iPhone™ can let a user input data/instructions with his/her two fingers (usually the thumb and the index finger), and uses related software/hardware to calculate the direction of movement and the distance between the two fingers to determine the corresponding movement, such as zoom in/out or rotating displayed contents such as photos and web pages.

In practice, when a user performs multi-touch rotation function with one hand, the maximum angle for one continuous rotation is limited by the simultaneous movements of the two fingers, usually less than 180 degrees; therefore, when it is necessary to rotate a larger angle such as 270 degrees, the user has to make several movements to finish the rotation.

Furthermore, when the user is riding in a car or is walking, it is difficult for the user to perform precise and stable multi-touch operations on a small touch screen, such as one on a mobile phone or a PDA, with only one hand.

### SUMMARY OF THE INVENTION

It is an object of the present invention to provide a method for controlling a display of a touch screen, a user interface of the touch screen, and an electronic device using the same for the user to control the display of the touch screen.

It is another object of the present invention to provide a method for controlling a display of a touch screen, a user interface of the touch screen, and an electronic device using the same for the user to easily rotate, move, or zoom in/out the content of the display.

In order to achieve the above object, an embodiment of the present invention discloses a method for controlling a display of a touch screen, the method comprising:

displaying at least one mode selection on the display of the touch screen, wherein each one of the at least one mode selections corresponds to a gesture control mode;

receiving a selection command for selecting one of the at least one mode selections;

entering the gesture control mode corresponding to the selected mode selection according to the selection command;

receiving a gesture control command adapted for the gesture control mode; and

executing a specific operation according to the gesture control command.

In response to the above embodiment, the present invention discloses a touch screen user interface, which comprises a first input region and a second input region; the first input region is provided for a user to select at least one gesture control mode; and the second input region is provided for the user to input a gesture control command adapted for the selected gesture control mode.

In another embodiment of the present invention, the present invention discloses a method for controlling a display of a touch screen and adapted for an electronic device comprising a touch screen, wherein the electronic device further comprises at least one button, which is electrically connected to the touch screen, the method comprising:

receiving a selection command by using the at least one button;

entering a gesture control mode according to the selection command;

receiving a gesture control command adapted for the gesture control mode; and

executing a specific operation according to the gesture control command.

A further embodiment of the present invention discloses a touch-based electronic device comprising a touch screen, a memory, and a processor, wherein the memory and the touch screen are electrically connected with the processor respectively, and the memory stores a control program for enabling the touch-based electronic device to control the display of the touch screen by using the method as described above.

### BRIEF DESCRIPTION OF THE DRAWINGS

FIG. 1 illustrates a block diagram of an electronic device according to the present invention;

FIG. 2 illustrates a flowchart of a method for controlling a display of a touch screen according to an embodiment of the present invention;

FIG. 3 to FIG. 8 illustrate views of controlling various displays of the touch screen in the present invention; and

FIG. 9 illustrates a flowchart of a method for controlling a display of a touch screen according to another embodiment of the present invention.

### DETAILED DESCRIPTION OF THE PREFERRED EMBODIMENT

The advantages and innovative features of the invention will become more apparent from the following detailed description when taken in conjunction with the accompanying drawings.

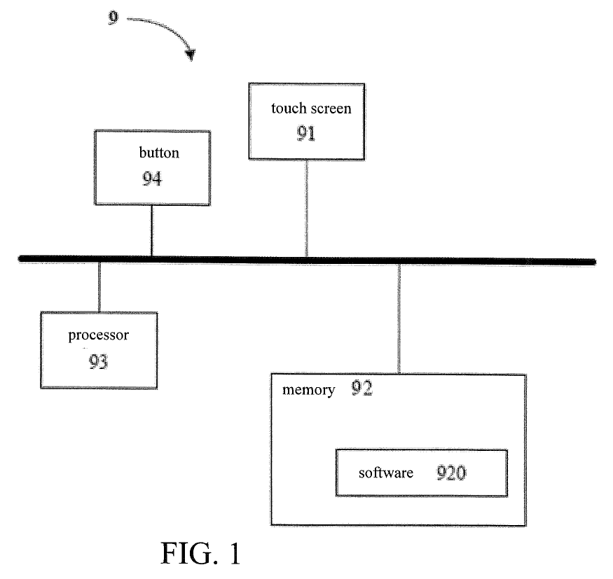

Please refer to FIG. 1. The present invention provides a method for controlling a display of a touch screen. The method is adapted for a touch screen 91 in an electronic device 9, such as a mobile phone, a personal data assistant (PDA), a portable navigation device (PND), and so on. The electronic device 9 further includes a memory 92 and a processor 93, wherein the memory 92 and the touch screen 91 are electrically connected with the processor 93 respectively, and the memory 92 stores software 920. The methods described below can be substantially implemented by the processor 93 executing the software 920; however, the methods can also be implemented by other means, such as a firmware or the like.

Furthermore, the touch screen 91 used in the present invention generally refers to all kinds of touch screens using resistive-type, capacitive-type, electromagnetic-type, supersonic-type, optical-type, or vision-type object detection techniques with direct or indirect contact mechanisms; for example, in electromagnetic-type, supersonic-type, optical-type, or vision-type object detection techniques, it is possible to detect the position relative to the object without the object touching the screen.

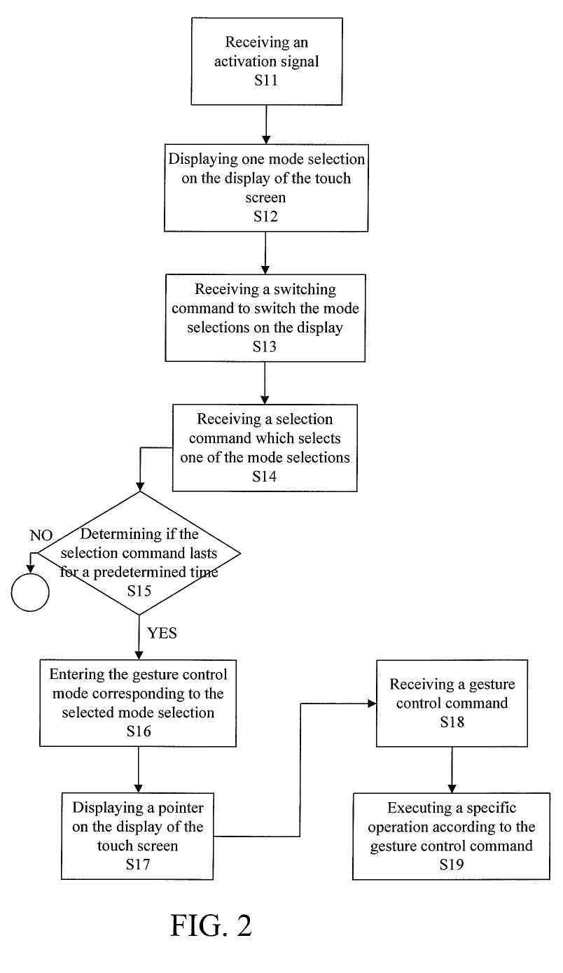

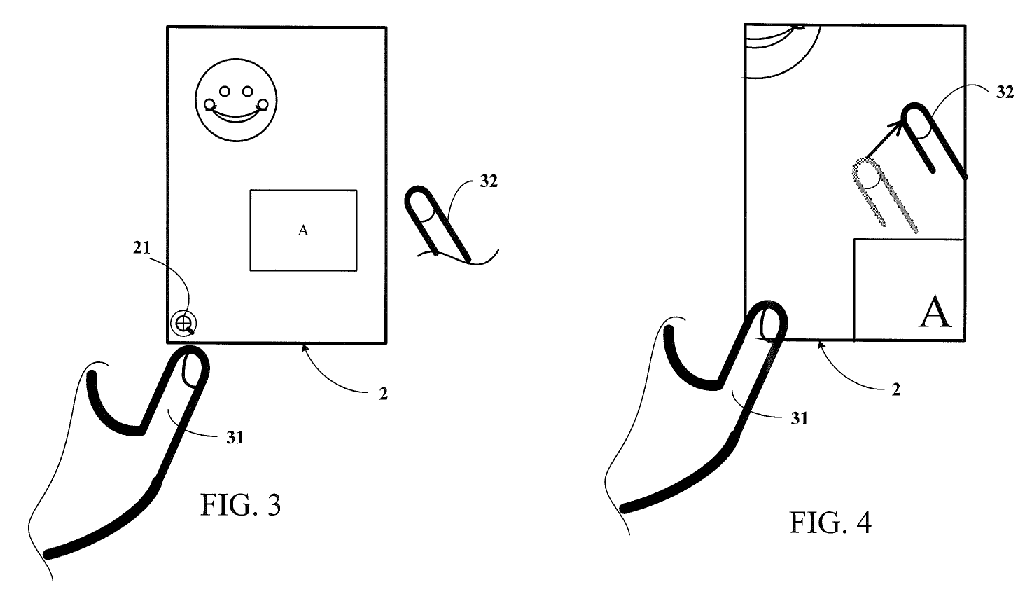

Please refer to both the flowchart of FIG. 2 and display view of FIG. 3. In this embodiment, the method comprises the following steps:

Step S11: First receiving an activation signal inputted by a user to enter the operation flow in the example. The user can touch a specific selection or any part of a display 2 of the touch screen of the electronic device 9, or press a preset physical button 94 of the electronic device 9 (as shown in FIG. 1), or input the activation signal by using another prior art input mechanism.

Step S12: Displaying at least one mode selection 21 on the display 2 of the touch screen, and each mode selection 21 corresponds to a gesture control mode respectively. The mode selection 21 can be shown on the display 2 of the touch screen in the form of a virtual button for the user to identify and select.

In other words, the mode selection 21 is shown on the display 2 of the touch screen after the user inputs the activation signal in Step S11 and S12; however, in other embodiments, the mode selection 21 can reside on the display 2 permanently.

For convenience, the mode selection 21 can be disposed at four corners of the display 2 of the rectangular touch screen, thereby allowing the user to use his/her finger of the hand holding the electronic device 9 to press the mode selection 21. For a user accustomed to holding the electronic device with his/her left hand to perform a gesture control command with his/her right hand, the mode selection 21 is preferably disposed at the lower left corner of the display 2.

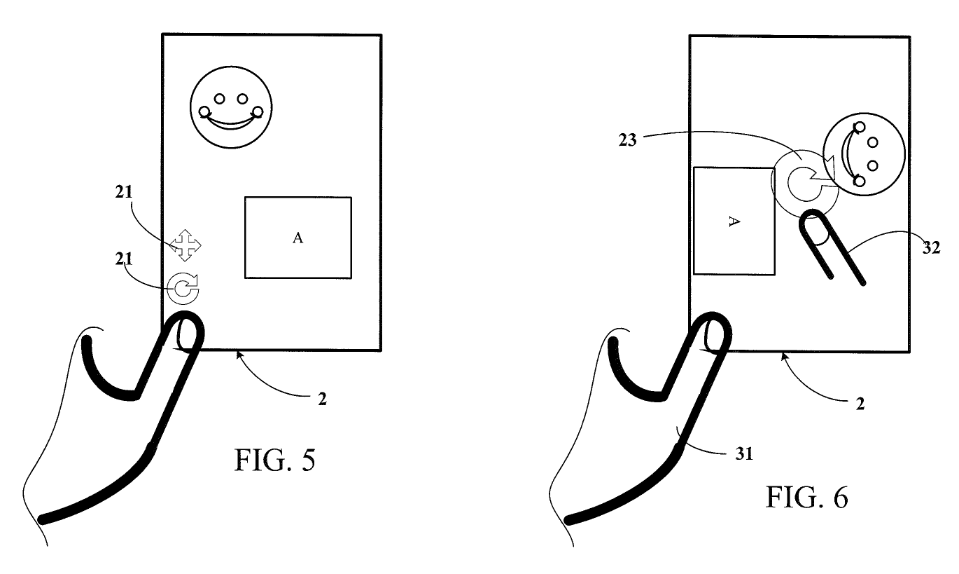

In this embodiment, the gesture control mode can be a zoom in/out, a move, or a rotation mode. The mode selection 21 shown in FIG. 3 corresponds to a zoom in/out gesture control mode. In another embodiment, shown in FIG. 5, the plurality of mode selections 21 correspond to a move, rotation, or zoom in/out gesture control mode from top to bottom respectively; in addition, different mode selections 21 are preferably illustrated by icons that can be intuitively linked with real gesture control movements. For example, the rotation gesture control mode of the mode selection 21 could correspond to a rotating arrow. Of course, the mode selection 21 can be illustrated with words, such as “rotation” or other suitable expressions.

Furthermore, as described above, the gesture control mode can be operated with the user's finger directly contacting the touch screen, or can be operated by a stylus pen or other tools, as in the applications of electromagnetic-type or optical-type touch screens, without the user's finger directly contacting the touch screen.

Furthermore, the zoom in/out, move, or rotation gesture control modes are better carried out in a single-touch manner; however, they can be carried out in a multi-touch manner as well. In addition, the gesture control modes can comprise other applications, such as switching photos, adjusting photo colors, adjusting the volume, etc.

Step S13: Receiving a switching command inputted by the user to switch the mode selections 21 corresponding to different gesture control modes.

In the embodiment shown in FIG. 3, the display 2 of the touch screen can only show a single mode selection 21; therefore, by using the step S13 to receive a switch command from the user, a plurality of mode selections 21 can be shown on the display 2 by turns. For example, the switch command can be activated by clicking twice continuously on the mode selection 21, and then another mode selection 21 is shown on the display 2. For example, the switch command can switch the display from the mode selection 21 corresponding to the zoom in/out operation to the mode selection 21 corresponding to rotation operation.

On the other hand, in the embodiment shown in FIG. 5, a plurality of mode selections 21 is shown on the display 2, and the mode selections 21 are disposed at the lower left corner of the display 2 from top to bottom sequentially; therefore, it is not necessary to switch the mode selections 21 at this time.

Step S14: Receiving a selection command which selects one of the mode selections 21. As shown in FIG. 4, in this embodiment, the user uses his/her finger 31 to press the mode selection 21 directly to generate the selection command.

Step S15: Determining if the selection command lasts for a predetermined time, such as two seconds; if it is determined that the selection command lasts for the predetermined time, the process goes to step S16; if not, then no further step is executed. In other words, this step prevents accidental misclicks from being regarded as selection commands and lists them as invalid selection commands.

Step S16: Entering the gesture control mode corresponding to the selected mode selection 21. As shown in FIG. 4, when the user presses the mode selection 21 corresponding to zoom in/out, the process goes to the zoom in/out gesture control mode.

Step S17: As shown in FIG. 6, displaying a pointer 23 around the center of the display 2 of the touch screen, wherein the pointer 23 corresponds to the mode selection 21 selected by the user in the display 2, which makes it easier for the user to identify the current gesture control mode. For example, a rotation pointer 23 is shown in FIG. 6 to represent that the current gesture control mode is the rotation gesture control mode; when the user selects a mode selection 21 corresponding to a zoom in/out or a move gesture control mode, the point around the center of the display 2 represents the zoom in/out or the move pointer 23. In this example, the icon used for the pointer 23 corresponds to the icon for the respective mode selection 21 to let the user intuitively identify the icon without remembering every icon; however, the icon of the pointer does not have to be the same as that of the mode selection.

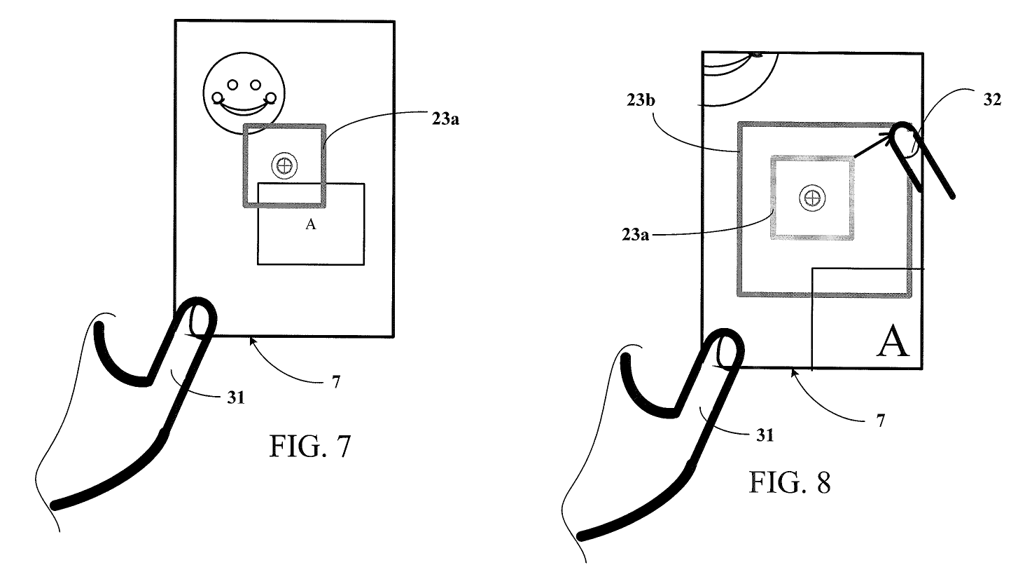

Furthermore, the pointer 23a shown in FIG. 7 can be enlarged or shrunk according to the content of the display 7 of the touch screen; for example, the zoom in/out pointer 23a in FIG. 8 can be enlarged to be the zoom in/out pointer 23b.

Step S18: Receiving a gesture control command adapted for the gesture control mode. As shown in FIG. 4, at this time, the user uses his/her right hand finger 32 to drag the pointer outward from the center of the display 2 to execute the gesture control command adapted for the zoom in/out gesture control mode.

Step S19: Executing a specific operation according to the gesture control command; this is shown in FIG. 4 as executing the specific operation of enlarging the display 2. For other gesture control modes, the specific operation can be move or rotation of at least part of the display 2. The content of the display 2 can be, for example, a web page, a desktop of an operating system, a photo, or other application software. The techniques of applying zoom in/out, move, or rotation to the content of the display 2 are well known in the art and therefore will not be further described.

As described in FIG. 4 and FIG. 6, when the user uses his/her finger 31 to press the mode selection 21 to enter the gesture control mode, the mode selections 21 on the lower left of the display 2 disappear; however, in other embodiments, the mode selections 21 can remain in the display 21. That is, the user can use a finger on his/her left hand to press or to switch the mode selections 21, and use his/her right hand to execute the gesture control command.

According to the above method, the present invention discloses a software-based touch screen user interface. As shown in FIG. 1, a touch-based electronic device 9 comprises a touch screen 91, a memory 92, and a processor 93, wherein the memory 92 and the touch screen 91 are electrically connected with the processor 93 respectively; the memory 92 stores a software 920, wherein the software can be implemented to execute all the methods in the present invention. The touch screen 91 comprises a first input region and a second input region; the first input region is provided for a user to select at least one gesture control mode; and the second input region is disposed at a position other than that of the first region and is provided for the user to input a gesture control command adapted for the selected gesture control mode.

In the embodiment shown in FIG. 3, the first input region is where the mode selections 21 reside and is provided for the user to select the gesture control mode corresponding to the selected mode selection 21; the second input region is a region that doesn't include the mode selections 21 in the display 21; while in the embodiment shown in FIG. 5, the first input region further includes a plurality of mode selections 21. As described above, the user can operate the first input region and the second input region simultaneously; that is, the user can press the mode selection 21 with a finger on his/her left hand and execute the gesture control command with his/her right hand.

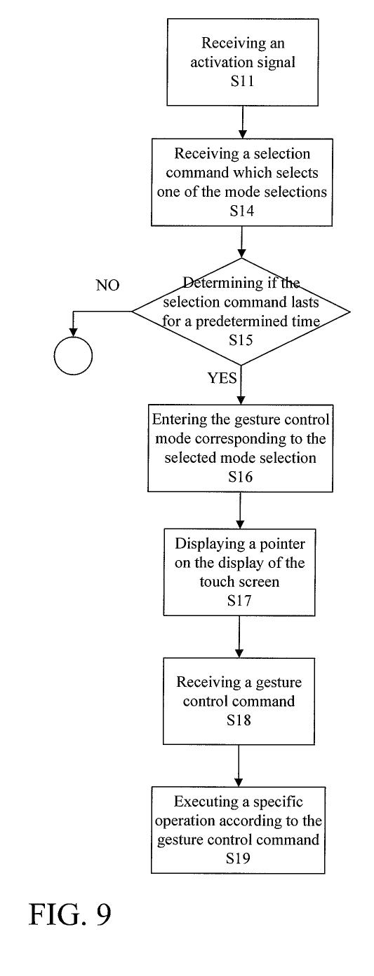

Please refer to the flowchart in FIG. 9 for another embodiment in the present invention. The difference between the present embodiment and that disclosed in FIG. 2 is that this flowchart skips step S12 in FIG. 2 and does not show the mode selection 21 in the display 2; alternatively, the electronic device 9 further comprises at least one button 94 representing a mode selection (as shown in FIG. 1); therefore, the user can press the button 94 with his/her finger to generate the selection command. Apart from using the button 94 to generate the selection command, various methods can be applied to generate the selection command; for example, a selection signal can be generated when the user touches the touch screen. After the selection command is received, a pointer is shown on the display for the user to identify the gesture control mode; therefore, the step S12 of displaying the mode selection is substantially skipped.

Additionally, as shown in FIG. 1, the present invention further discloses an electronic device 9 comprising a touch screen 91; the electronic device 9 can be a small touch screen notebook computer, a personal data assistant (PDA), or a touch screen mobile phone. The electronic device 9 uses the methods described above to control the display of the touch screen 91.

In summary, the present invention discloses a novel multi-touch method to let the user press to select or to switch one or more mode selections with his/her finger, such as a finger on the left hand and execute the gesture control command with another hand, such as his/her right hand. Compared with prior art multi-touch techniques, the present invention is obviously advantageous in:

1. The prior art multi-touch technique requires the user to use two fingers to operate at the center of the touch screen; on the contrary, the present invention practically requires only one finger (such as the right hand index finger) to execute the gesture control command; therefore, the present invention covers less area in application and helps the user view the content of the display more clearly.

2. In practice, the prior art multi-touch technique requires the user to use two fingers to finish the rotation operation; therefore, the maximum angle for one continuous rotation is limited by the simultaneous movements of the two fingers and is usually less than 180 degrees; on the contrary, the present invention only requires the user to use one finger to execute the rotation gesture control command, so one continuous rotation of over 360 degrees can be easily accomplished.

3. The prior art multi-touch technique requires the user to employ two fingers; on the contrary, the present invention can let the user hold the electronic device with one hand and execute the gesture control command with one finger of the other hand; therefore, the user can hold and operate the electronic device more stably and precisely to avoid misclicking.

4. Since most users are still accustomed to inputting instructions/data with stylus pens, in the present invention, it is possible for a user to use a stylus pen instead of his/her finger to perform the gesture control command, thereby providing a friendly and flexible operation environment.

5. The mode selection function can be implemented by hardware or buttons in any other forms and is not limited to using the touch screen to receive the gesture control command and to work with a software; therefore, the touch screen used in the present invention is not necessarily a touch screen such as a capacitive-type touch screen which can support a multi-touch function; it can be a non multi-touch touch screen like a traditional resistive-type touch screen to save material costs.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A method for controlling a display of a touch screen, comprising:
displaying at least one mode selections on the display of the touch screen, wherein each one of the at least one mode selections corresponds to a gesture control mode;
receiving a selection command for selecting one of the at least one mode selections;
entering the gesture control mode corresponding to the selected mode selection;
receiving a gesture control command adapted for the gesture control mode; and
executing a specific operation according to the gesture control command.

2. The method as claimed in claim 1, wherein the at least one mode selection is disposed at one of four corners of the display of the touch screen.

3. The method as claimed in claim 1, wherein before receiving a gesture control command, the step further comprises:
displaying a pointer on the display on the touch screen, wherein the pointer corresponds to a selected mode selection for a user to identify the gesture control mode.

4. The method as claimed in claim 3, wherein the pointer comprises any one of a zoom in/out pointer, a move pointer, or a rotation pointer.

5. The method as claimed in claim 1, wherein the gesture control mode comprises any one of a zoom in/out mode, a move mode, or a rotation mode.

6. The method as claimed in claim 1, wherein the specific operation comprises zooming in/out, moving, or rotating at least part of the content on the display of the touch screen.

7. The method as claimed in claim 1 further comprising:
receiving a switch command for switching to the at least one mode selection on the display of the touch screen.

8. The method as claimed in claim 1, wherein the gesture control mode is substantially a single-touch mode.

9. A method for controlling a display of a touch screen and adapted for a electronic device comprising a touch screen and at least one button electrically connected to each other, the method comprising:
receiving a selection command by using the at least one button;
entering a gesture control mode according to the selection command;
receiving a gesture control command adapted for the gesture control mode; and
executing a specific operation according to the gesture control command.

10. The method as claimed in claim 9, wherein before receiving the gesture control command, the method further comprises:
displaying a pointer on the display on the touch screen, wherein the pointer is provided for a user to identify the gesture control mode.

11. The method as claimed in claim 10, wherein the pointer comprises any one of a zoom in/out pointer, a move pointer, or a rotation pointer.

12. The method as claimed in claim 9, wherein the gesture control mode comprises any one of a zoom in/out mode, a move mode, or a rotation mode.

13. The method as claimed in claim 9, wherein the specific operation comprises zooming in/out, moving, or rotating at least part of the content on the display of the touch screen.

14. The method as claimed in claim 9, wherein the gesture control mode is substantially a single-touch mode.

15. A method for controlling a display of a touch screen, comprising:
receiving a selection command, wherein the selection command is substantially generated by a user touching the touch screen;
entering a gesture control mode according to the selection command, wherein the gesture control mode comprises any one of a zoom in/out mode, a move mode, or a rotation mode;
displaying a pointer on the display on the touch screen, wherein the pointer is provided for the user to identify the gesture control mode;
receiving a gesture control command adapted for the gesture control mode; and
executing a specific operation according to the gesture control command.

16. A touch-based electronic device comprising a touch screen, a memory, and a processor, wherein the memory and the touch screen are electrically connected with the processor respectively; the memory stores a control program for enabling the touch-based electronic device to control the display of the touch screen by using the method as claimed in claim 1.
